(19) United States
(12) Patent Application Publication
(10) Pub. No.: US 2014/0155159 A1
(43) Pub. Date: Jun. 5, 2014

(54) TAP-SWIPE INTERACTIONS TO RELEASE ACTION SEQUENCES FOR DIGITAL CHARACTERS

(71) Applicant: Trigger Happy, Ltd., Auckland (NZ)

(72) Inventor: Karl Butler, Aukland (NZ)

(73) Assignee: Trigger Happy, Ltd., Auckland (NZ)

(21) Appl. No.: 14/095,812

(22) Filed: Dec. 3, 2013

Related U.S. Application Data
(60) Provisional application No. 61/732,853, filed on Dec. 3, 2012.

(51) Int. Cl. A63F 13/00

(52) U.S. Cl. CPC A63F 13/00
USPC 463/31

(57) ABSTRACT

A machine-controlled method can include a touch-sensitive display of an electronic device visually presenting to a user a digital character, and a processor of the electronic device causing the digital character to perform action sequences responsive to tap-swipe operations performed by the user on the touch-sensitive display.

### CROSS-REFERENCE TO RELATED APPLICATION

This application claims the benefit of U.S. Provisional Patent Application No. 61/732,853, titled “TAP-SWIPE INTERACTIONS TO RELEASE ACTION SEQUENCES FOR DIGITAL CHARACTERS” and filed on Dec. 3, 2012, which is hereby incorporated herein by reference in its entirety.

### TECHNICAL FIELD

The disclosed technology pertains generally to custom animation tools and techniques, particularly for use on a mobile electronic device such as a smartphone or tablet computing device.

### BACKGROUND

Custom animation software has gained significantly popularity over the years. Such popularity, coupled with the continuing advances in personal electronic equipment, particularly handheld devices such as tablet computers and smartphones, has resulted in an increasing demand for powerful and flexible custom animation software that may be used on or by a number of different electronic devices. Current custom animation software, however, still tends to leave certain users with a desire for more creative ways to manipulate characters, particularly predetermined or predefined characters and action sequences that can be performed by such characters.

Thus, there remains a need for a way to address these and other problems associated with the prior art.

### BRIEF DESCRIPTION OF THE DRAWINGS

FIG. 1A illustrates a first example of a digital character displayed on a touch-sensitive screen or other type of display of an electronic device in accordance with certain embodiments of the disclosed technology.

FIG. 1B illustrates a user completing a tap-swipe operation by swiping his or her finger in a certain manner and/or direction in accordance with the first example.

FIG. 1C illustrates the digital character of FIGS. 1A-B moving in a first direction in accordance with the first example.

FIG. 1D illustrates the digital character of FIGS. 1A-C moving in a second direction in accordance with the first example.

FIG. 2A illustrates a second example of a digital character displayed on a touch-sensitive screen or other type of display of an electronic device in accordance with certain embodiments of the disclosed technology.

FIG. 2B illustrates a user completing a tap-swipe operation by swiping his or her finger in a certain manner and/or direction in accordance with the second example.

FIG. 2C illustrates the digital character of FIGS. 2A-B performing a first action in accordance with the second example.

FIG. 2D illustrates the digital character of FIGS. 2A-C performing a second action in accordance with the second example.

FIG. 3A illustrates a third example of a digital character displayed on a touch-sensitive screen or other type of display of an electronic device in accordance with certain embodiments of the disclosed technology.

FIG. 3B illustrates a user completing a tap-swipe operation by swiping his or her finger in a certain manner and/or direction in accordance with the third example.

FIG. 3C illustrates the digital character of FIGS. 3A-B performing a first action in accordance with the third example.

FIG. 3D illustrates the digital character of FIGS. 3A-C performing a second action in accordance with the third example.

### DETAILED DESCRIPTION

Embodiments of the disclosed technology generally pertain to a variety of custom animation tools and techniques that may be executed, performed, and controlled on a computing device such as an Apple® iPhone device, iPad device, or iPod Touch device, or virtually any smartphone, tablet computing device, portable media device, or other type of personal computing device, handheld or otherwise.

Embodiments of the disclosed technology generally include action sequences that may be applied to one or more digital characters by way of a user instruction provided by way of a tap-swipe interaction, e.g., a tap operation followed by a swipe operation, with a touchscreen, for example. As described herein, an action sequence may include one or more of a virtually unlimited number of actions [or combinations thereof] that a digital character may perform. For example, a digital character may walk, jump, wave, dance, or otherwise move responsive to a corresponding tap-swipe interaction. Such action sequences are generally predetermined, preplanned, precreated, or otherwise readily available to a user for application to a digital character, e.g., a character from a book, television show, or movie, or a digital character type, such as human, animal, cartoon character, or computer-generated imagery (CGI) character.

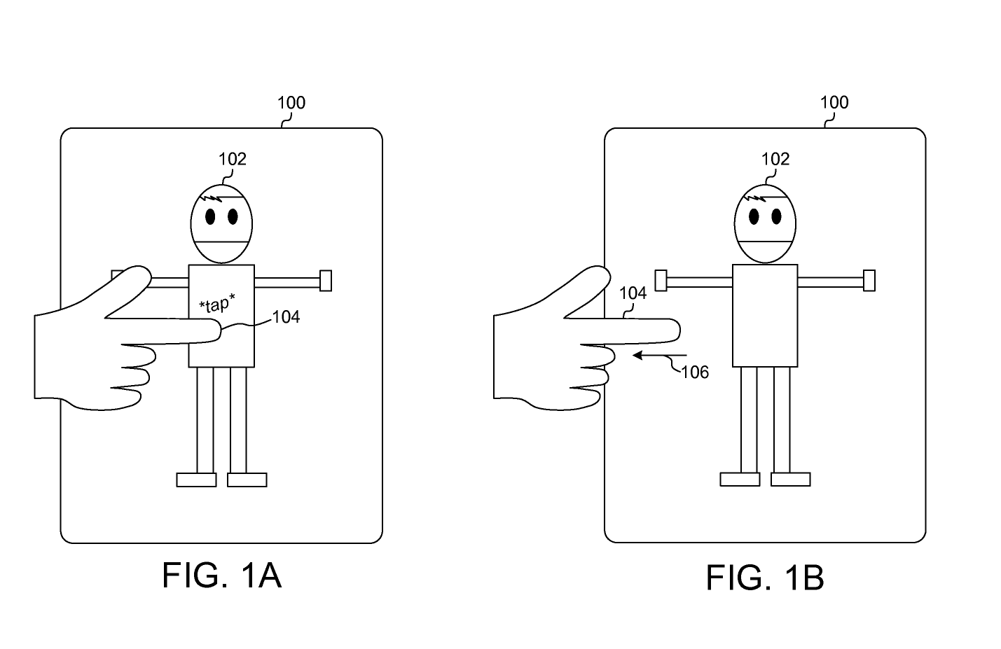

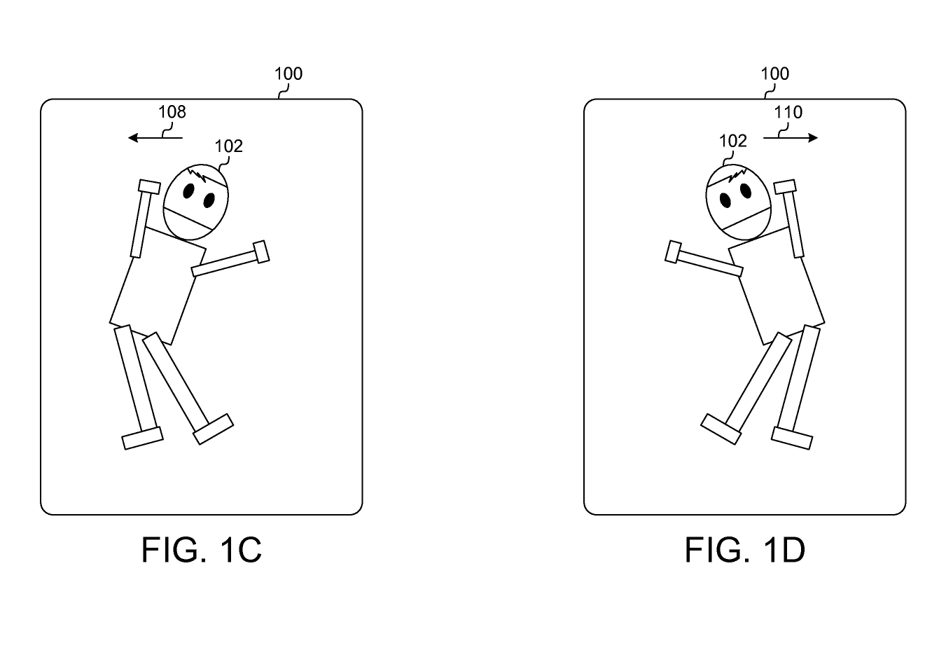

FIGS. 1-3 illustrate three distinct types of action sequences that may be applied to, e.g., caused to be performed by, a digital character displayed by a display device such as a touchscreen. The action sequences illustrated by FIGS. 1-3 represent three of a virtually unlimited number of action sequences that may be made available to a user.

FIG. 1A illustrates a first example of a digital character 102 displayed on a touch-sensitive screen 100 or other type of display of an electronic device such as a smartphone or tablet computing device, for example. The displayed character 102 may be selected from a library of pre-made characters or it may be imported from an external application or data store. In alternative embodiments, the character 102 may be created by the user prior to the performing of any of the following functionality thereon.

While the digital character 102 in the example is a cartoon person, it will be appreciated that the action sequence about to be described, and any other action sequence, may be applied to virtually any particular character or character type.

In the example, a user performs a tap operation by tapping his or her finger 104 on the digital character 102 (here, on the midsection of the digital character 102). In certain embodiments, the system may immediately begin to identify particular action sequences that may be performed by the digital character 102 based on the tap operation.

In FIG. 1B, the user performs a subsequent swipe operation 106 by swiping his or her finger 104 in a certain manner and/or direction (here, to the user's left). Responsive to the tap-swipe interaction illustrated by FIGS. 1A-1B, the system, e.g., a processor of the electronic device, may cause the digital character 102 to perform a certain action sequence corresponding to the tap-swipe interaction.

In the example, the action sequence that corresponds to the tap-swipe interaction includes the digital character 102 performing a hip-thrusting sequence, e.g., by moving its hip first to the user's left 108 and then to the user's right 110, as illustrated by FIGS. 1C and 1D, respectively. In the example, the character's 102 arms and legs also move in accordance with the hip motions. In certain embodiments, the action sequence consists entirely of the bodily motions 108 and 110 illustrated by FIGS. 1C and 1D, respectively; in other embodiments, any or all of the bodily motions 108 and 110 may repeat, e.g., in a perpetual or diminishing manner.

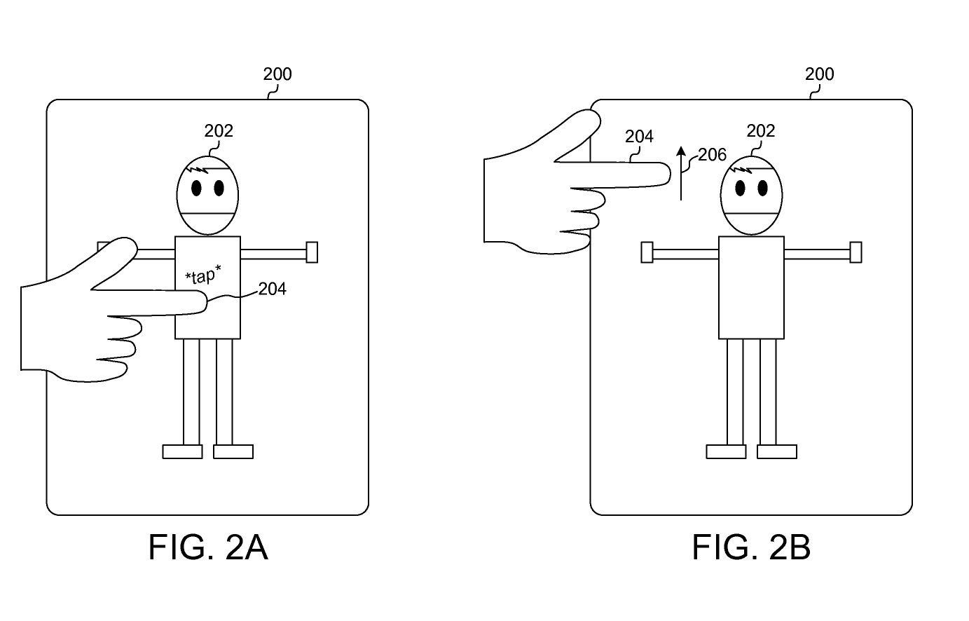

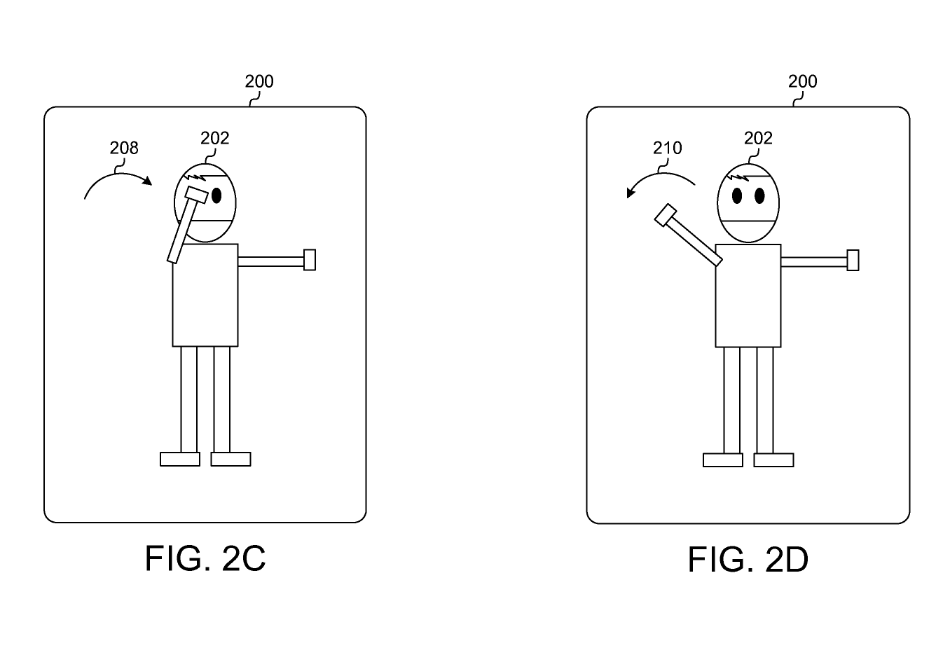

FIG. 2A illustrates a second example of a digital character 202 displayed on a touch-sensitive screen or other type of display of an electronic device such as a smartphone or tablet computing device, for example. It will be appreciated that the action sequence about to be described, and any other action sequence, may be applied to virtually any particular character or character type.

In the example, a user performs a tap operation by tapping his or her finger 204 on the digital character 202 (here, on the midsection of the digital character 202). The system may immediately begin to identify particular action sequences that may be performed by the digital character 202 based on the tap operation.

In FIG. 2B, the user performs a subsequent swipe operation 206 by swiping his or her finger 204 in a certain manner and/or direction (here, upwardly). Responsive to the tap-swipe interaction illustrated by FIGS. 2A-2B, the system, e.g., a processor of the electronic device, may cause the digital character 202 to perform a certain action sequence corresponding to the tap-swipe interaction.

In the example, the action sequence that corresponds to the tap-swipe interaction includes the digital character 202 performing a hand-waving sequence, e.g., by moving its right hand first to the user's right 208 and then back to the user's left 210, as illustrated by FIGS. 2C and 2D, respectively. In certain embodiments, the action sequence consists entirely of the hand motions 208 and 210 illustrated by FIGS. 2C and 2D, respectively; in other embodiments, any or all of these motions may repeat.

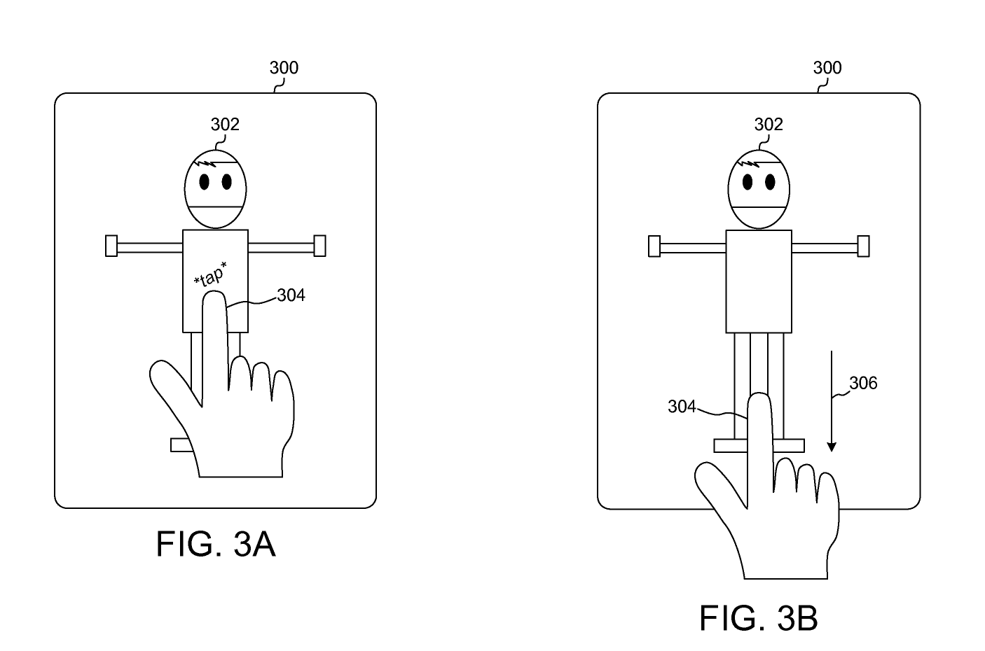

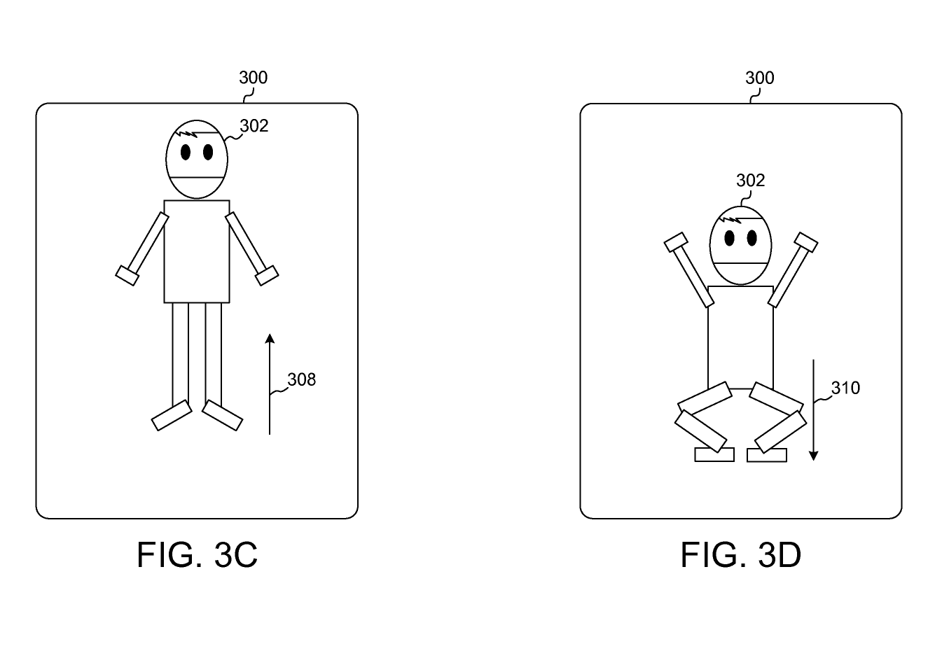

FIG. 3A illustrates a third example of a digital character 302 displayed on a touch-sensitive screen or other type of display of an electronic device such as a smartphone or tablet computing device, for example. It will be appreciated that the action sequence about to be described, and any other action sequence, may be applied to virtually any particular character or character type.

In the example, a user performs a tap operation by tapping his or her finger 304 on the digital character 302 (here, on the midsection of the digital character 302). The system may immediately begin to identify particular action sequences that may be performed by the digital character 302 based on the tap operation.

In FIG. 3B, the user performs a subsequent swipe operation 306 by swiping his or her finger 304 in a certain manner and/or direction (here, downwardly). Responsive to the tap-swipe interaction illustrated by FIGS. 3A-3B, the system, e.g., a processor of the electronic device, may cause the digital character 302 to perform a certain action sequence corresponding to the tap-swipe interaction.

In the example, the action sequence that corresponds to the tap-swipe interaction includes the digital character 302 performing a jumping sequence, e.g., by first jumping in an upward manner 308 and then landing 310 in a resulting squat-like position, as illustrated by FIGS. 3C and 3D, respectively. In certain embodiments, the action sequence consists entirely of the motions 308 and 310 illustrated by FIGS. 3C and 3D, respectively; in other embodiments, these jumping motions may repeat.

Certain embodiments allow a user to create a combination of multiple movements. For example, an initial tap interaction by the user may cause the application to wait—and expect—further instructions. The user may then provide a series of instructions (e.g., via corresponding interactions with the application) to cause the application to release a combination of corresponding movements for the digital character.

In a certain example, responsive to a tap interaction followed by a swipe left interaction, a second swipe left interaction, and a swipe up interaction by the user, the application may cause the digital character to perform two sequential hip thrust actions and then a hand wave action.

In another example in which the user performs a tap operation followed by a swipe down operation, a swipe left operation, and then another swipe down operation, the application may cause the digital character to jump, then perform a hip-thrust, and then jump again.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smart phones, and the like. These machines may be implemented as part of a cloud computing arrangement.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, non-transitory physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A machine-controlled method, comprising:
a touch-sensitive display of an electronic device visually presenting to a user a digital character; and
responsive to at least one characteristic of a first tap-swipe operation performed by the user on the touch-sensitive display, a processor of the electronic device causing the digital character to perform a first action sequence comprising a first plurality of actions to be performed by the digital character.

2. The machine-controlled method of claim 1, wherein the at least one characteristic of the first tap-swipe operation includes a direction of the tap-swipe operation.

3. The machine-controlled method of claim 2, wherein the first plurality of actions to be performed by the digital character includes a first movement by the character in the same direction as that of the tap-swipe operation.

4. The machine-controlled method of claim 3, wherein the first plurality of actions to be performed by the digital character includes a second movement by the character in a direction opposite that of the tap-swipe operation.

5. The machine-controlled method of claim 4, wherein the first movement occurs before the second movement.

6. The machine-controlled method of claim 4, wherein the second movement occurs before the first movement.

7. The machine-controlled method of claim 4, wherein the first and second movements continue in an alternating manner.

8. The machine-controlled method of claim 7, wherein the first and second movements continue in a perpetual manner.

9. The machine-controlled method of claim 7, wherein the first and second movements continue in a diminishing manner.

10. The machine-controlled method of claim 4, wherein the first and second movements correspond to the entire digital character.

11. The machine-controlled method of claim 10, wherein the first movement includes a jumping motion.

12. The machine-controlled method of claim 11, wherein the second movement includes a landing and squatting motion.

13. The machine-controlled method of claim 4, wherein the first and second movements correspond to at least one body part of the digital character.

14. The machine-controlled method of claim 13, wherein the at least one body part includes an arm of the digital character.

15. The machine-controlled method of claim 14, wherein first movement includes the arm of the digital character moving in a first direction.

16. The machine-controlled method of claim 15, wherein second movement includes the arm of the digital character moving in a second direction that is generally opposite the first direction.

17. The machine-controlled method of claim 1, further comprising the processor of the electronic device causing the digital character to perform a second action sequence comprising a second plurality of actions to be performed by the digital character responsive to at least one characteristic of a second tap-swipe operation performed by the user on the touch-sensitive display.

18. The machine-controlled method of claim 1, wherein the electronic device is a handheld computing device.

19. One or more non-transitory machine-readable storage media configured to store machine-executable instructions that, when executed by a processor, cause the processor to perform the machine-controlled method of claim 1.

20. A portable electronic device, comprising:
a touch-sensitive display configured to visually present to a user a digital character; and
a processor configured to cause the digital character to appear to perform an action sequence responsive to a tap-swipe operation performed by the user on the touch-sensitive display, the action sequence comprising a plurality of actions to be performed by the digital character, wherein the action sequence corresponds to the tap-swipe operation.
